(19) United States
(12) Patent Application Publication
(10) Pub. No.: US 2012/0085879 A1
(43) Pub. Date: Apr. 12, 2012

(54) DUAL-LAYER SUCKING DISC

(76) Inventor: Yang Hao, Zhongli City (TW)

(21) Appl. No.: 12/899,601

(22) Filed: Oct. 7, 2010

(51) Int. Cl. F16B 47/00

(52) U.S. Cl. 248/363

(57) ABSTRACT

A dual-layer sucking disc includes a sucking body capable of adhering to a smooth surface. The sucking body has an annular closing surface which is a plane and disposed around the periphery of the sucking body. The sucking body has a concave bottom to form a sucking chamber. An inner soft layer is provided in the sucking chamber of the sucking body, which is capable of adhering to a rough surface. The inner soft layer is attached to the sucking chamber except the annular closing surface. The present invention can adhere to a smooth airtight surface with the annular closing surface or a rough airtight surface with the inner soft layer. The present invention is simply in configuration and can be manufactured with ease and used widely.

### BACKGROUND OF THE INVENTION

1. Field of the Invention

The present invention relates to a sucking disc, and more particularly, to a dual-layer sucking disc capable of adhering to a smooth airtight surface or a rough airtight surface.

2. Description of the Prior Art

A vacuum sucking disc is used to adhere to a smooth glass surface for people to hang different articles so as to save space and to take the articles conveniently. The sucking disc can be secured or moved with ease.

Most of conventional sucking discs can adhere to a smooth and airtight surface only, such as glass. A conventional sucking disc comprises a hard pad and a rubber soft pad wrapping the hard pad. The bottom of the soft pad has a chamber. The soft pad is pressed to adhere to a working surface through the hard pad by exhausting the air in the chamber. By the pressure difference inside and outside, the rubber soft pad can adhere to a smooth airtight surface and a rough airtight surface. However, this sucking disc is complicated and has a high cost, and cannot be used widely. Accordingly, the inventor of the present invention has devoted himself based on his many years of practical experiences to solve this problem.

### SUMMARY OF THE INVENTION

The primary object of the present invention is to provide a dual-layer sucking disc, which can adhere to a smooth airtight surface or a rough airtight surface.

Another object of the present invention is to provide a dual-layer sucking disc, which is simply in configuration and can be manufactured with ease and used widely.

In order to achieve the aforesaid objects, the present invention comprises a sucking body capable of adhering to a smooth surface. The sucking body has a concave bottom to form a sucking chamber therein and an annular closing surface which is a plane and disposed around the periphery of the sucking chamber. An inner soft layer is attached to an inner wall of the sucking chamber. The inner soft layer is capable of adhering to a rough surface.

Preferably, the inner soft layer is attached to the sucking chamber except the annular closing surface.

Preferably, the sucking body has a hardness greater than that of the inner soft layer.

Preferably, wherein the sucking body is made of a material which has a hardness of more than 65 Shore and the inner soft layer is made of a soft material which has a hardness of zero Shore.

Preferably, the sucking body and the inner soft layer are made of either Thermoplastic Elastomer (TPE) or Thermoplastic Rubber (TPR). In particular, the inner soft layer has viscosity.

Preferably, an inner wall of the sucking chamber has a groove thereon and the inner soft layer has an outer wall which is attached to the sucking body and has a protruding rib corresponding to the groove.

Preferably, the sucking chamber has two annular grooves and the softer layer has two annular protruding ribs.

Preferably, the sucking body has a connection hole at an upper portion thereof and the connection hole is a stepped hole which is narrowed outward.

Compared to the prior art, the present invention has the following features. First, through the sucking body capable of adhering to a smooth surface and the inner soft layer which is disposed in the sucking chamber and can adhere to a rough surface, the annular closing surface around the periphery of the sucking body is used to adhere to a smooth airtight surface and the inner soft layer is used to adhere to a rough airtight surface. Thus, the present invention can adhere to a smooth airtight surface or a rough airtight surface. Second, the inner wall of the sucking chamber and the outer wall of the inner soft layer have the corresponding grooves and protruding ribs, so that the inner soft layer and the sucking body can be coupled firm. Furthermore, the connection hole at the upper portion of the sucking body can be connected with different components for hanging or securing different articles. The present invention is simply in configuration and can be manufactured with ease.

### BRIEF DESCRIPTION OF THE DRAWINGS

FIG. 1 is a perspective view according to a preferred embodiment of the present invention;

FIG. 2 is a cross-sectional view according to the preferred embodiment of the present invention;

FIG. 3 is an exploded cross-sectional view according to the preferred embodiment of the present invention;

FIG. 4 is a cross-sectional view according to the preferred embodiment of the present invention adhered to a rough airtight surface; and

FIG. 5 is a cross-sectional view according to the preferred embodiment of the present invention adhered to a smooth airtight surface; and

### DETAILED DESCRIPTION OF THE PREFERRED EMBODIMENTS

Embodiments of the present invention will now be described, by way of example only, with reference to the accompanying drawings.

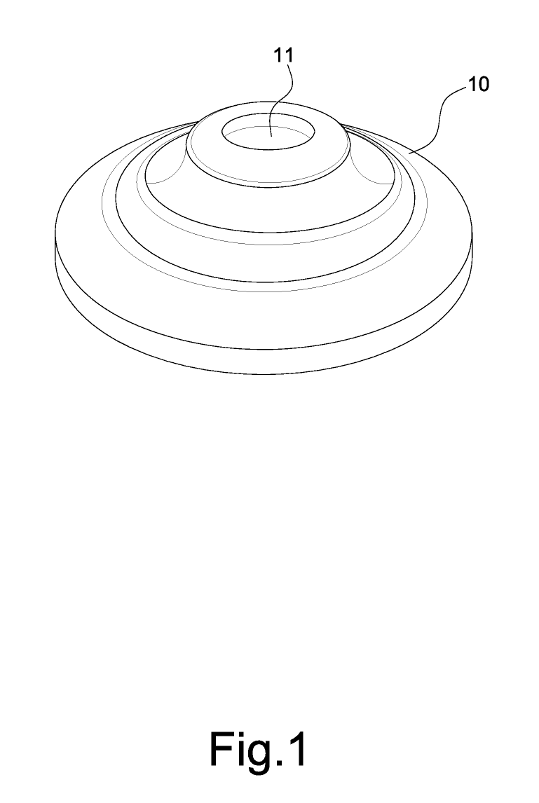

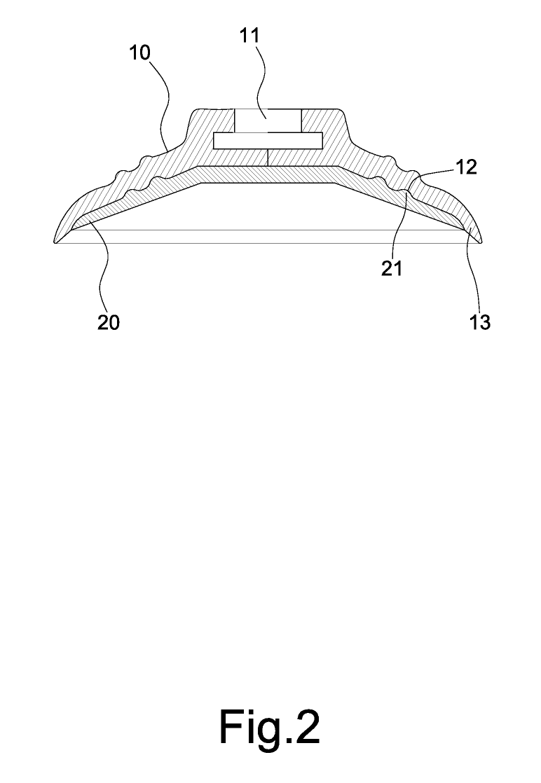

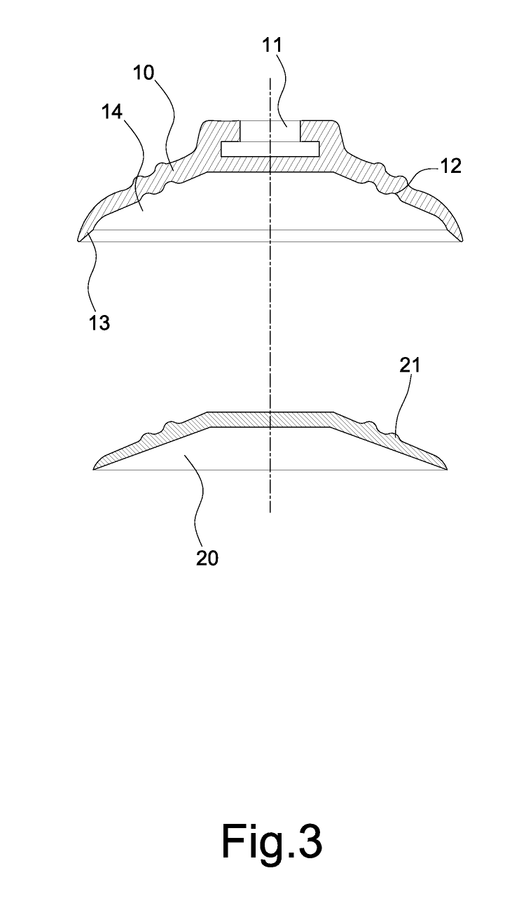

As shown in FIG. 1 through FIG. 3, the dual-layer sucking disc according to a preferred embodiment of the present invention comprises a sucking body 10 capable of adhering to a smooth surface. The sucking body 10 has an annular closing surface 13 which is a plane and disposed around the periphery of the sucking body 10. The sucking body 10 has a concave bottom to form a sucking chamber 14. In this embodiment, the periphery of the bottom of the sucking body 10 has a round shape. The sucking chamber 14 has a sphere-like inner wall which has two grooves 12 thereon. The sucking body 10 has a connection hole 11 at an upper portion thereof. The connection hole 11 is a stepped hole 11 which is narrowed outward.

An inner soft layer 20 is provided in the sucking chamber 14 of the sucking body 10, which is capable of adhering to a rough surface. The annular closing surface 13 is not contact with the inner soft layer 20. In this embodiment, the periphery of the bottom of the inner soft layer 20 also has a round shape. The inner soft layer 20 has an outer wall which is attached to the sucking body 10 and has protruding ribs 21 corresponding to the grooves 12.

The hardness of the sucking body 10 is greater than that of the inner soft layer 20. The sucking body 10 is made of a material which has a hardness of more than 65 Shore. The inner soft layer 20 is made of a soft material which has a hardness of zero Shore.

The sucking body 10 and the inner soft layer 10 are made of either Thermoplastic Elastomer (TPE) or Thermoplastic Rubber (TPR).

The usage and working principle according to the embodiment of the present invention are described below.

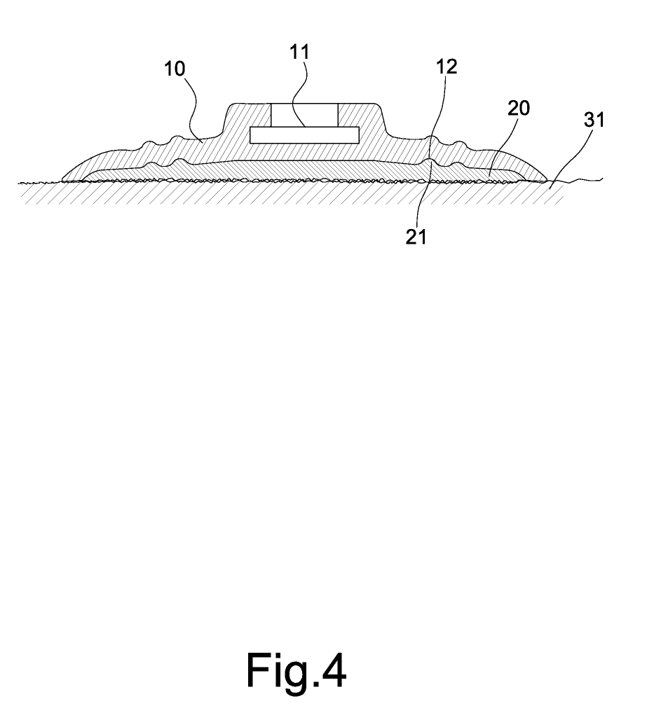

As shown in FIG. 4, when the working surface is a rough airtight surface 31 and the sucking disc is pressed toward the working surface, the sucking body 10 and the inner soft layer 20 will be deformed, with the bottom of the inner soft layer 20 to adhere to the working surface. There are a plurality of tiny sealed spaces formed between the bottom of the inner soft layer 20 and the working surface. By the pressure difference between the sealed spaces and the external of the sucking disc, the sucking disc can adhere to the working surface firm. Besides, the inner soft layer 20 is made of the soft material which has a hardness of zero Shore. The inner soft layer 20 has a certain viscosity. The soft material can fully adhere to the rough airtight surface 31.

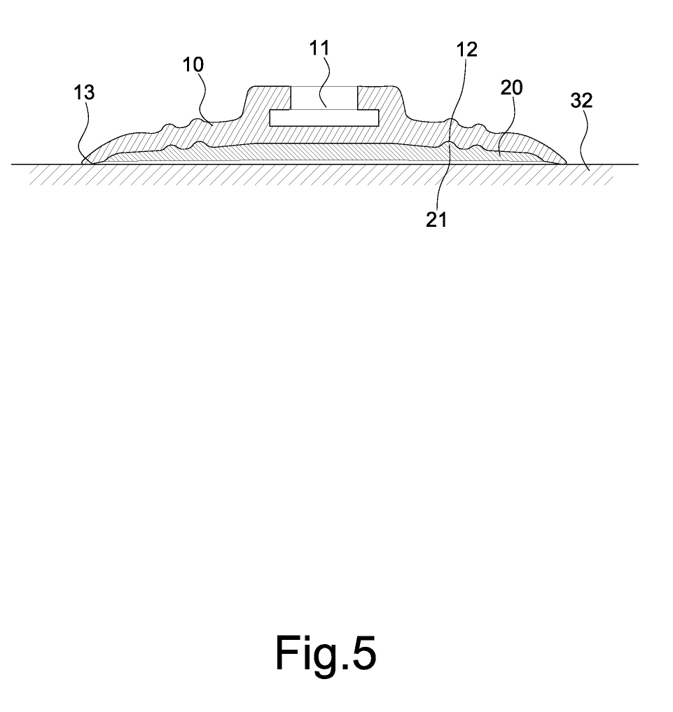

As shown in FIG. 5, the working surface is a smooth airtight surface 32 and the sucking disc is pressed toward the working surface, the sucking body 10 and the inner soft layer 20 will be deformed, with the annular closing surface 13 of the sucking body 10 to adhere to the working surface to form a sealed space. By the pressure difference between the sealed space and the external of the sucking disc, the sucking disc can adhere to the working surface firm.

Accordingly, the present invention has the following features.

1. Through the sucking body capable of adhering to a smooth surface and the inner soft layer which is attached to the sucking chamber and can adhere to a rough surface, the annular closing surface around the periphery of the sucking body is used to adhere to a smooth airtight surface and the inner soft layer is used to adhere to a rough airtight surface. Thus, the present invention can adhere to a smooth airtight surface or a rough airtight surface.

2. The inner wall of the sucking chamber and the outer wall of the inner soft layer have the corresponding grooves and protruding ribs, so that the inner soft layer and the sucking body can be coupled firm.

3. The connection hole at the upper portion of the sucking body can be connected with different components for hanging or securing different articles.

4. The present invention is simply in configuration and can be manufactured with ease.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A dual-layer sucking disc, comprising
a sucking body having a concave bottom to form a sucking chamber therein and an annular closing surface which is a plane and disposed around the periphery of the sucking chamber; and
an inner soft layer disposed in the sucking chamber of the sucking body, the inner soft layer having an annular outer edge not exceeding the annular closing surface.

2. The dual-layer sucking disc as claimed in claim 1, wherein the inner soft layer is attached to the sucking chamber except the annular closing surface.

3. The dual-layer sucking disc as claimed in claim 1, wherein the sucking body has a hardness greater than that of the inner soft layer.

4. The dual-layer sucking disc as claimed in claim 3, wherein the sucking body is made of a material which has a hardness of more than 65 Shore and the inner soft layer is made of a soft material which has a hardness of zero Shore.

5. The dual-layer sucking disc as claimed in claim 1, wherein an inner wall of the sucking chamber has a groove thereon and the inner soft layer has an outer wall which is attached to the sucking body and has a protruding rib corresponding to the groove.

6. The dual-layer sucking disc as claimed in claim 5, wherein the sucking chamber has two annular grooves and the softer layer has two annular protruding ribs.

7. The dual-layer sucking disc as claimed in claim 1, wherein the sucking body has a connection hole at an upper portion thereof and the connection hole is a stepped hole which is narrowed outward.

8. The dual-layer sucking disc as claimed in claim 1, wherein the sucking body is made of one of Thermoplastic Elastomer (TPE) and Thermoplastic Rubber (TPR).

9. The dual-layer sucking disc as claimed in claim 1, wherein the inner soft layer is made of one of Thermoplastic Elastomer (TPE) and Thermoplastic Rubber (TPR).

10. The dual-layer sucking disc as claimed in claim 1, wherein the inner soft layer has viscosity.
